(19) United States
(12) Patent Application Publication
(10) Pub. No.: US 2003/0123686 A1
(43) Pub. Date: Jul. 3, 2003

(54) USE MOLDABLE RADIO-FREQUENCY-ATTENUATING MATERIAL IN HEARING AIDS

(76) Inventors: H. STEPHEN BERGER, GEORGETOWN, TX (US); DILLARD GILMORE, AUSTIN, TX (US); JOSEPH FAZIO, RINGOES, NJ (US); SUNIL CHOJAR, LEBANON, NJ (US)

Correspondence Address: ELSA KELLER, SIEMENS CORPORATION, INTELLECTUAL PROPERTY DEPARTMENT, 186 WOOD AVENUE SOUTH, ISELIN, NJ, 08830

(21) Appl. No.: 08/851,655

(22) Filed: May 5, 1997

(51) Int. Cl. H04R 25/00

(52) U.S. Cl. 381/322

(57) ABSTRACT

Radio-frequency-attenuating material is disposed within a hearing aid shell to avoid electromagnetic interference with the hearing aid circuitry. The material can be injected into the hearing aid shell, molded around hearing aid components or wires, or used to line the hearing aid shell. In alternatives, the hearing aid shell itself incorporates radio-frequency-attenuating material.

### TECHNICAL FIELD OF THE INVENTION

The present invention relates to hearing aids, and more specifically to the use of telecommunications devices by wearers of hearing aids.

### BACKGROUND OF THE INVENTION

Millions of Americans suffer from hearing loss. Most commonly, hearing loss is of one of four types. In slope loss, the ability to hear high frequencies is lost while the ability to hear sounds in the low frequencies is retained. In reverse slope loss, the ability to hear low frequencies is lost while the ability to hear sounds in the high frequencies is retained. Less frequently, the hearer loses the ability to hear sounds in all normally audible frequencies. Finally, some people lose the ability to hear in only a small range of frequencies.

Typically, someone who suffers from hearing loss wears a hearing aid. Hearing aids are electroacoustical devices worn to compensate for a hearing impairment by amplifying sound. They include aids placed behind the ear, aids placed in the ear, and aids placed in the external auditory canal. Hearing aids generally consist of a microphone, an amplifier, and a speaker, but are increasingly sophisticated instruments. Many have automatic gain control and digital signal processing; they can often be programmed to remedy a specific pattern of frequency loss specified by a user's prescription. Hearing aids utilize analog or digital circuitry, or both. Most hearing aids in use today are analog.

Programmable hearing aids include amplifiers and filters controlled by an external digital source. Typically, such a hearing aid will include a memory module and a microprocessor to access the memory locations and to control the frequency response.

Although hearing aids are of particular use in conversations and other face-to-face situations, they are less useful when combined with signals from electronic devices. Feedback, distortion and radio frequency (RF) interference often interfere with a wearer's hearing aid. Some hearing aid wearers report interference from simply walking past a wireless device in use. As the use of wireless communications devices proliferates, this problem is becoming more and more serious.

What is needed is an invention that allows hearing aid wearers to use electronic and telecommunications devices, such as wireless telephones and cellular telephones without interference.

### SUMMARY OF THE INVENTION

The present invention includes an apparatus and method which incorporate a moldable attenuating material into a hearing aid. Most interference from a cellular or wireless device originates from its antenna. In order to suppress interference adequately, the attenuating material is preferably positioned within the near field of the antenna. Because a hearing aid is worn near the antenna, disposing attenuating material in or on the hearing aid is an effective way of avoiding RF interference.

In one embodiment of the present invention, components and wires are positioned within the hearing aid shell. Then, moldable attenuating material is injected into the hearing aid shell. The attenuating material effectively fills the cavity and surrounds the wires and other components. The injection of such material provides an easy, cost-effective way to isolate components and wires from RF fields and to equalize induced currents, significantly decreasing RF interference.

In alternative embodiments, moldable attenuating material is molded around wires and components before the wires and components are placed in a hearing aid shell. In other embodiments, the attenuating material can be placed in or on the hearing aid shell, as for example by providing a lining or shield in the inside or on the outside of the hearing aid shell. In another embodiment, the attenuating material can be manufactured into the hearing aid shell itself.

Copending application Ser. No. 08/639,651, incorporated herein by reference, describes an approach to decreasing interference between hearing aids and wireless communications devices. Application Ser. No. 08/639,651 concerns the use of ferrite materials in a flexible matrix to create an RF shadow that effectively avoids interference. This application applies the teachings of that application but also develops new approaches to reducing interference.

The approach to interference suppression described in that application began with the recognition that near-field conditions shaped the problem. An electromagnetic field comprises a reactive near field, a near field, and a far field. The reactive near field is typically characterized as the region within λ/2π from the radiation source; the near field may be characterized as within λ/2 of the source. The far field is beyond that. The characteristics of an electromagnetic field depend on whether it is in the reactive near field, the near field, or the far field. In particular, in the far field, the electric and magnetic fields combine to form a plane wave having an impedance of 377 Ω, where impedance is E/H. However, in the reactive near field or the near field, the value of E/H is determined by characteristics of the source; furthermore, the electrical and magnetic fields must be considered separately. In most wireless communications devices, the applicable source is the antenna.

When a hearing aid wearer uses a wireless communications device such as a cellular telephone, the hearing aid and antenna are typically in close enough proximity that the hearing aid is within the near field of the antenna. Thus, many approaches to solving the problem of interference that might be applicable to the far field will not be effective. With most antennas used with wireless communications devices, as for example the quarter-wave dipole antenna typical of many cellular telephones, the magnetic field effects predominate and the magnetic field component is the primary coupling component.

Accordingly, one aspect of the present solution focuses on attenuating the magnetic field component (H) of the near field of the wireless communications device. In a preferred embodiment, a magnetically absorptive material such as a ferrite is placed within the hearing aid. When wireless telecommunications devices are used with hearing aids, the hearing aid is typically within the near field of the antenna generating the magnetic field. A material with relatively high permeability is used, where permeability (μ) is defined as the quotient of the peak value of the flux density and the peak value of the applied field strength. Permeability is a complex parameter including a real component μ′ that represents the reactive portion and the imaginary portion μ″ that represents the magnetic loss factor.

Ferrites as a class tend to have relatively high permeability; their permeability is a function of EM frequency. Typically, as frequency increases, μ′ of the material first remains constant, then rises to a maximum value, and finally falls off sharply, with loss component μ″ rising to a peak as μ′ falls. The losses are due to spin precession resonance, as described more fully in the above-identified copending application.

### BRIEF DESCRIPTION OF THE FIGURES

FIG. 1 is a schematic cross-section diagram of a hearing aid as in the background art.

FIG. 2 is a schematic diagram of an encasement of components and wires by filling a shell with attenuating material in accordance with the present invention.

FIG. 3 is a schematic diagram of an encasement of components and wires by attenuating material in accordance with an alternative embodiment of the present invention.

FIG. 4 is a schematic diagram of an encasement of components and wires by ceramic ferrites in accordance with an alternative embodiment of the present invention.

FIGS. 5A and 5B are cross sections of alternative encasements of wires within the ceramic ferrites of FIG. 4.

FIG. 6 is a schematic diagram of the use of ceramic ferrite beads in accordance with the present invention.

FIG. 7 is an illustration of the incorporation of attenuating material in a hearing aid shell in accordance with the present invention.

FIG. 8 is a schematic diagram of a hearing aid showing attenuating material lining the plastic shell of a hearing aid.

FIG. 9 is a schematic diagram of a hearing aid showing attenuating material lining a compartment that encases a hearing aid component.

FIG. 10 shows attenuating material filling a compartment that encases a hearing aid component, in accordance with the present invention.

FIG. 11 is a flow chart of a method of manufacturing a hearing aid in accordance with the present invention.

FIG. 12 is a flow chart of an alternative method of manufacturing a hearing aid in accordance with the present invention.

### DETAILED DESCRIPTION OF THE PREFERRED EMBODIMENTS

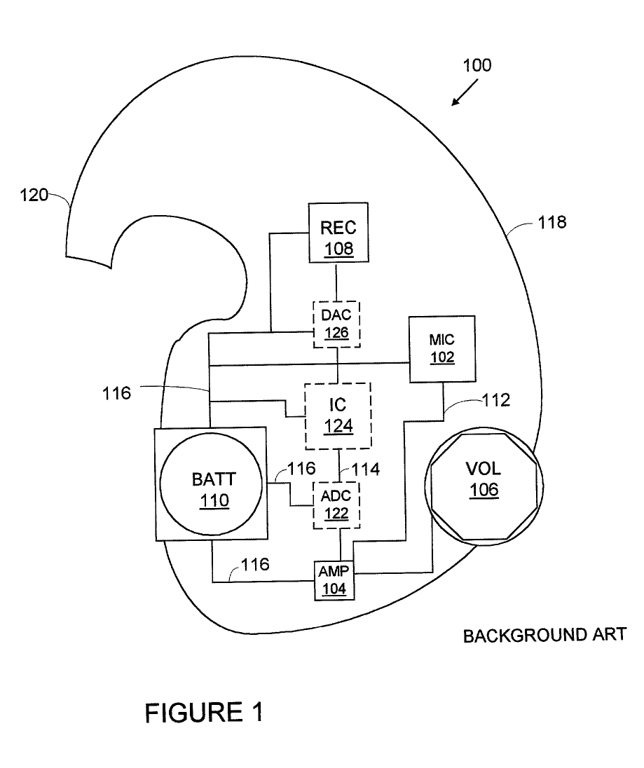

An analog hearing aid 100 as in the background art is schematically depicted in FIG. 1, when viewed without optional components 122, 124, 126. A microphone 102 picks up sound, which is transmitted to an amplifier 104. Amplifier 104 is controlled by a volume controller 106. The amplifier amplifies the sound and transmits it to a receiver 108. A battery 110 provides electrical power for the system.

Microphone wires 112 connect the microphone to the amplifier. Amplifier wires 114 connect the amplifier to the receiver. In addition, power supply wires 116 run from battery 110 to all components. These components and wires are enclosed within a hearing aid shell 118. Typically, hearing aid shell 118 is composed of hard plastic. A tube 120 conducts sound into the ear canal.

Digital processing is also used in the background art. Accordingly, this alternative is also shown in FIG. 1. Accordingly, the system shown in FIG. 1 optionally includes an analog-to-digital converter (ADC) 122, a processor (integrated circuit or IC) 124, and a digital-to-analog converter (DAC) 126. The ADC converts the microphone output to a digital signal for the processor, and the DAC converts the processor output back to analog. ADC 122, processor 124, and DAC 126 are shown in dashed lines to indicate that they are optional.

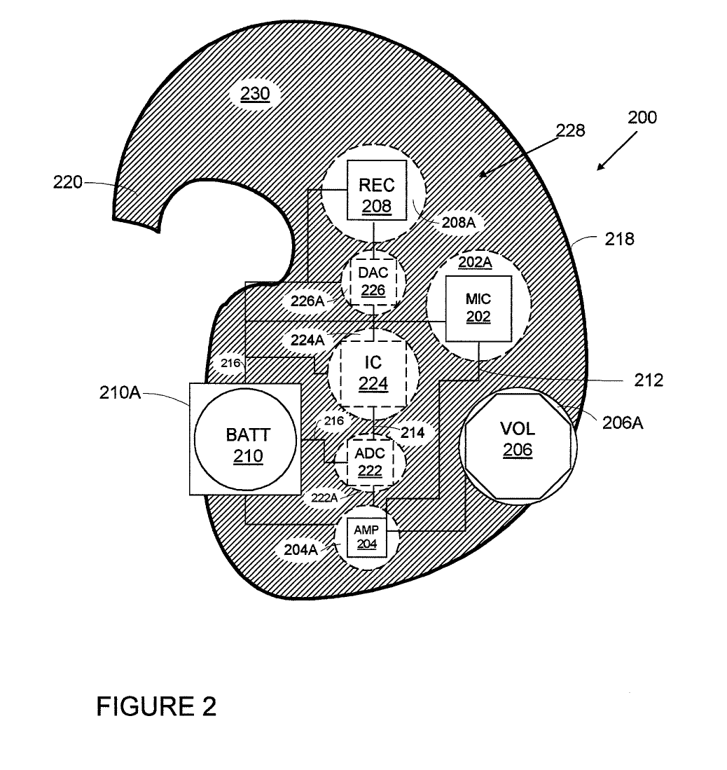

FIG. 2 shows one embodiment in accordance with the present invention. A hearing aid 200 includes a microphone 202, an amplifier 204, volume control 206, a receiver 208, and a battery 210, with functions similar to those of corresponding components of the background art. Microphone wires 212 connect the microphone to the amplifier. Amplifier wires 214 connect the amplifier to the receiver. In addition, power supply wires 216 run from battery 210 to all components. All components are contained within a plastic hearing aid shell 218 with a tube 220, as schematically shown in FIG. 2.

FIG. 2 also depicts components used in digital embodiments, including an analog-to-digital converter (ADC) 222, a processor 224, and a digital-to-analog converter (DAC) 226. The ADC converts the input to the processor to a digital signal, and the DAC converts the processor output back to analog. ADC 222, processor 224, and DAC 226 are shown in dashed lines to indicate that they are optional components.

When the components are in place, a cavity 228 of hearing aid shell 218 is filled with an attenuating material 230. In the preferred embodiment, an injectable attenuating material is used because it has more potential to improve electromagnetic immunity than a rigid attenuating material such as a ceramic ferrite, and because it is simpler to manufacture. Injecting a ferrite eliminates the need for a sintering step that is often needed in ceramic ferrites. Furthermore, injection is far simpler than, for example, forming a ceramic piece that would require precise fitting and placement of wires. Preferably, attenuating material 230 is a ferrite-impregnated silicone rubber. Other potting or binding compounds can also provide the matrix for the attenuant.

A compartment 206A for volume control 206 is designed to protect the dial within the interior of hearing aid shell 218 while allowing free rotation of the dial to enable volume level selection. Compartment 206A protects the volume control dial from dust and prevents the attenuating material from gumming the mechanism. A compartment 210A of battery 210 shields the battery from injectable suppressant and allows battery 210 to be changed.

Hearing aids can be retrofitted in accordance with the present invention. To retrofit, the hearing aid can be opened and the interior cavity injected with ferrite-impregnated silicone rubber. After injection, the hearing aid can be closed again. In the preferred embodiment, the silicone rubber cures at room temperature for 24 to 48 hours. After curing, the hearing aid is ready for use. ECCOSORB (a registered trademark of Emerson and Cuming, Inc.), a magnetically absorptive castable silicone rubber material manufactured by Emerson and Cuming, Inc., 869 Washington Street, Canton, Mass. 02021. ECCOSORB CR-S 124 is preferably used with devices in the 1800 MHZ range. ECCOSORB contains powdered iron particles of 60 mesh size dispersed in a silicone rubber medium, and is sold commercially to suppress current flow in the microwave frequency.

By means of explanation and not of limitation, it is believed that placement of attenuating materials can create an “RF shadow”, much as described in the above identified copending application. Placing components (as, for example, a microphone) or wires within the RF shadow can be an effective way to avoid interference.

It is further believed that placement of attenuating materials around wires (particularly long wires) and between components decreases interference by putting a common inductance on all covered lines. In essence, the materials combine with the circuitry to create a longitudinally oriented transformer. The common inductance reduces the overall amplitudes of currents induced by interfering electromagnetic fields and tends to equalize these induced currents across the circuit, resulting in reduced interference. Accordingly, either system (placement within the RF shadow or creating common currents) can be effective. Furthermore, combinations of the systems and customized placement of attenuating materials can be devised to lessen interference based on particular hearing aid designs.

In an alternative embodiment illustrated in FIG. 2, the microphone, amplifier, and receiver are “potted”, or enclosed within small individual compartments 202A, 204A, and 208A, respectively, that enclose and protect the components from the attenuating material. Compartments 202A, 204A, and 208A are shown in dashed lines to indicate that they are optional. When present, the ADC, processor, and DAC also can be enclosed in compartments 222A-226A, respectively.

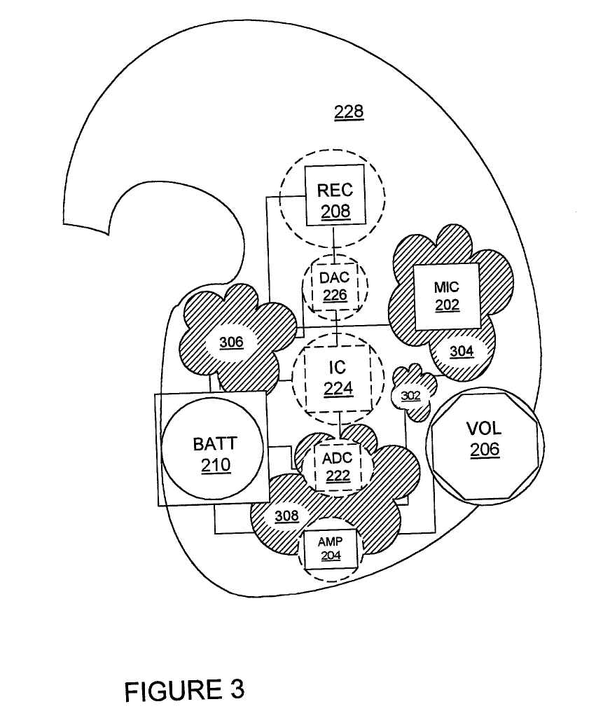

In alternative embodiments, the ferrite-impregnated silicone rubber can be molded around wires and components. The hearing aid shell can then be closed. FIG. 3 shows a hearing aid system 300. Parts corresponding to those of the system of FIG. 2 have like numbers.

FIG. 3 shows an irregularly shaped packets 302, 304, 306, and 308 of attenuating material encasing wires and components. Packet 302 encasing a single wire, wire 212 between the microphone and the amplifier. Packet 304 encases a single component, the microphone. In the embodiment illustrated, microphone 202 does not have a compartment (such as compartment 202A of FIG. 2) isolating it from the attenuating material, although this is a matter of design choice depending on characteristics of a particular system.

Packet 306 encases plural wires between components, while packet 308 encases plural components and plural wires. Any set of components and/or wires can be encased, depending on the requirements of the system.

The packets can be hand molded, machine molded, or created by injecting small amounts of attenuating material. Hearing aids can be retrofitted by adding attenuating materials and closing the hearing aid. In the preferred embodiment, ferrite-implanted silicone rubber is used. Ferrite-implanted silicone rubber offers certain manufacturing advantages as it can easily be molded around components, does not require precise fitting, and need not be sintered.

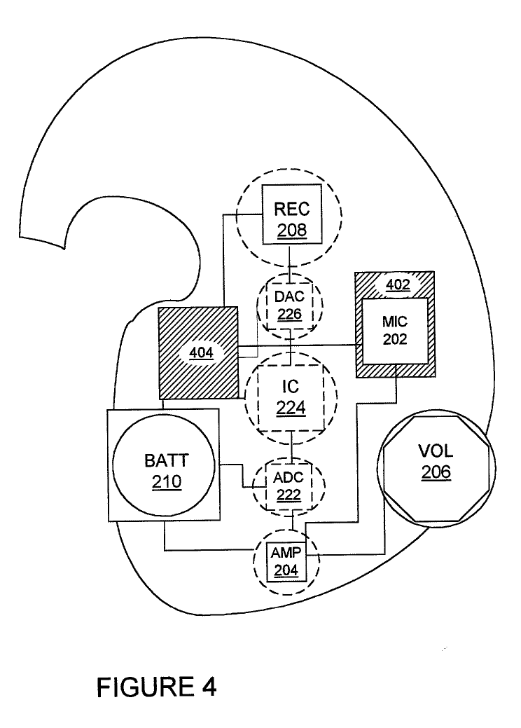

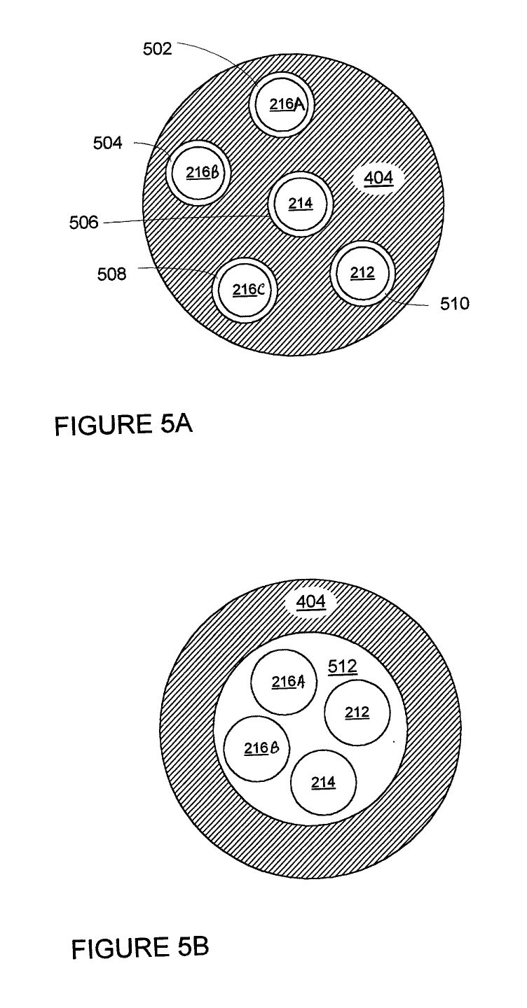

The use of ceramic ferrites is schematically shown in FIG. 4. As seen in FIG. 4, ceramic ferrites can encase components and wires. A ceramic ferrite 402 encases microphone 202. A second ceramic ferrite 404 encloses wires running between components. The ceramic ferrites are molded and sintered. Components can then be placed into compartments formed in the ceramic ferrite. Similarly, wires can be placed into wire channels formed in the ferrite. A wire channel can encase single or plural wires. The hearing aid shell is then closed. FIGS. 5A and 5B schematically depict cross-sections of alternative encasements of wires 212, 214, and 216A-C. The components can be placed (or wires lengthened) so that wires run through a single ceramic ferrite, as depicted in FIGS. 5A and 5B. Alternatively, the ferrites can hold fewer or different wires, and/or more ferrites can be used.

In the embodiment shown in FIG. 5A, ceramic ferrite 404 includes several wire channels 502-510. Each channel holds an individual wire (212-216A-C), and wires are isolated from each other by attenuating material that separates the channels. Wires 216A-C are power supply wires, each of which runs from the battery to a component.

FIG. 5B depicts a ceramic ferrite with a single wire channel 512 through it. Plural wires 212-216A-B run through the channel.

Again, the embodiments depicted in FIG. 4 and FIGS. 5A and 5B admit of combinations and variations; ceramic ferrites can enclose single or plural components and wires (or combinations), and/or can be combined with moldable attenuating material. In the embodiment illustrated in FIG. 4, microphone 202 is not enclosed in a compartment such as compartment 202A of FIG. 2. In alternatives, compartments can enclose components within ceramic ferrites.

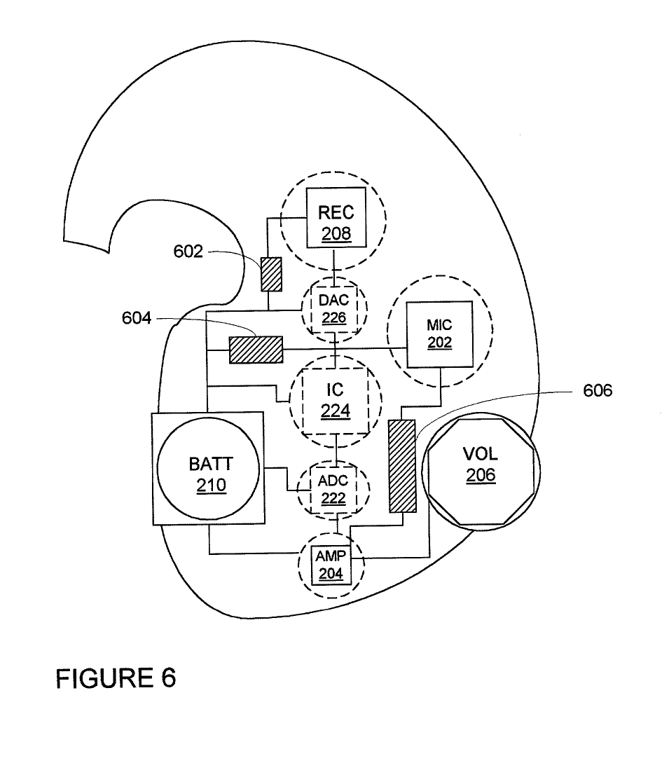

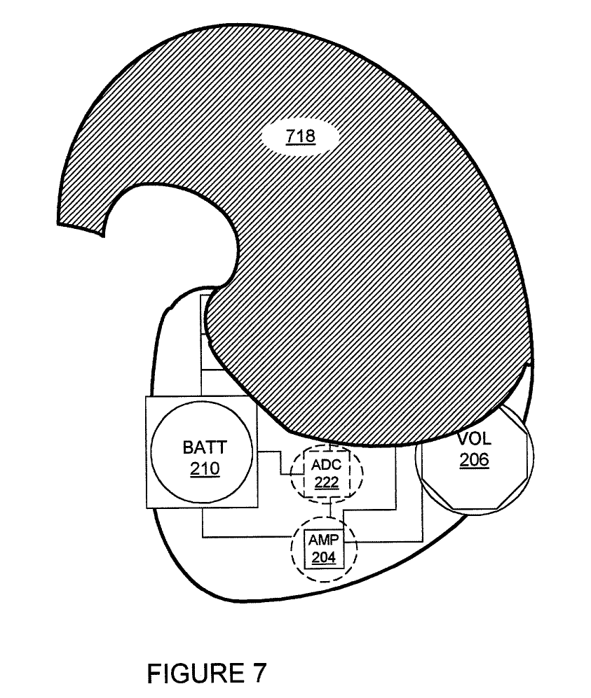

In another alternative shown in FIG. 6, ceramic beads 602, 604, and 606 are placed around individual wires, as depicted in FIG. 6. In another embodiment, iron particles or particles of ferrite or other attenuating material are distributed in a hearing aid shell 718 itself, as shown in FIG. 7.

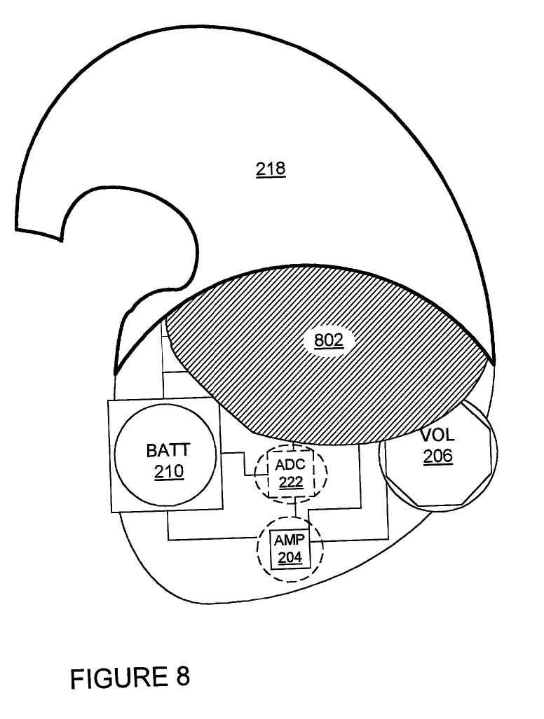

In an alternative embodiment, schematically shown in FIG. 8, attenuating material forms a lining 802 for hearing aid shell 218. Lining 802 and shell 218 are shown in cutaway view to reveal the interior of the hearing aid. Although the attenuating material can be silicone rubber that includes ferrite material, other materials such as ferrites, conductive materials, and/or metallic composites also can be used. The use of silicone rubber (or other flexible or moldable medium) offers advantages in the manufacture or construction of linings. Attenuant-bearing silicone rubber can be formed into thin sheets that can easily be cut and fitted into small, irregularly shaped receptacles such as a hearing aid or even a compartment for a hearing aid component.

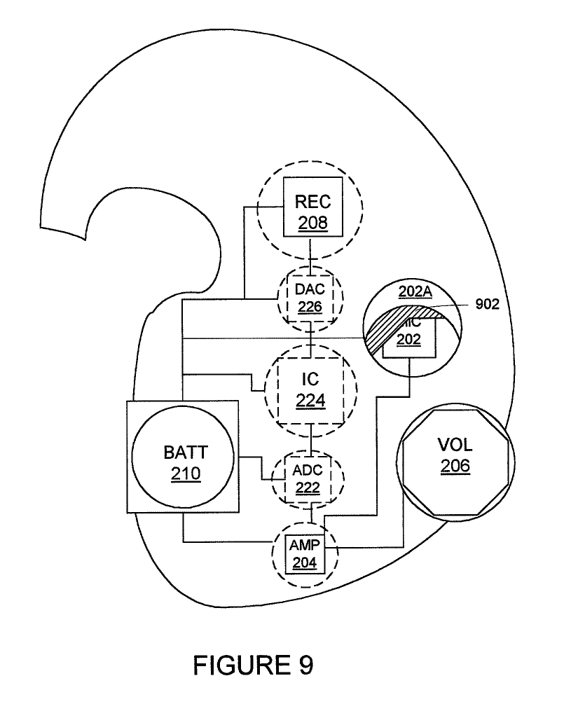

FIG. 9 schematically depicts an attenuating material that forms a lining 902 of compartment 202A, which encloses microphone 202. Since microphones are often particularly susceptible to radio frequency interference, encasing the microphone in a compartment lined with attenuating material can improve the interference levels experienced by the hearing aid wearer. Similarly, other component compartments can be lined with attenuating material.

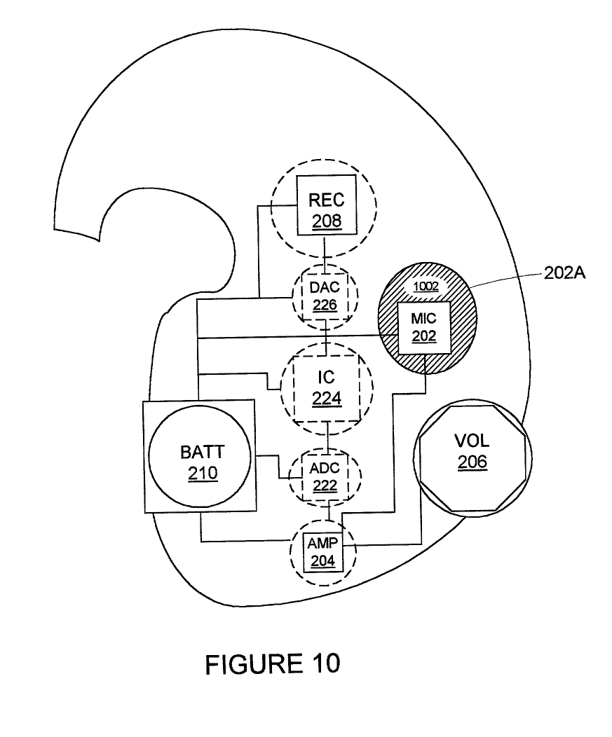

Alternatively, injectable attenuant can be injected into a compartment, such as microphone compartment 202A to form an attenuating filling 1002, as schematically illustrated in FIG. 10. In another alternative, the attenuating material covers the hearing aid shell. The hearing aid shell can be soft silicone rubber or can be hard plastic.

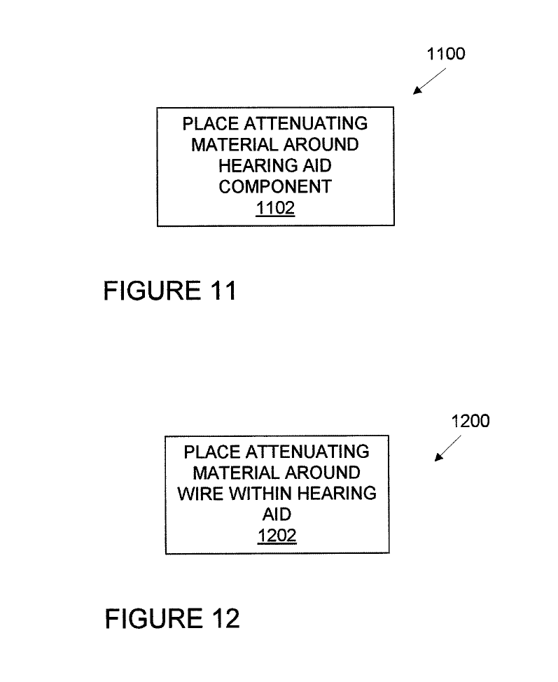

FIG. 11 is a flow chart of a method 1100 of manufacture in accordance with the present invention. Attenuating material is placed, at a step 1102, around a hearing aid component such as a microphone, amplifier, receiver, battery, ADC, DAC, and/or IC.

The method of placement of material includes injection as well as casting, molding, and forming by hand, machine, or device. The method further includes placement of material around plural components.

FIG. 12 is a flow chart of an alternative method 1200 of manufacture in accordance with the present invention. Attenuating material is placed, at a step 1202, around a wire between components of a hearing aid. The method of placement of material includes injection as well as casting, molding, and forming by hand, machine, or device. The method further includes placement of material around plural wires. The methods of FIG. 11 and FIG. 12 are not exclusive, and may be combined.

The invention admits of variations and permutations of described embodiments. For example, ceramic ferrite beads may be attached to some wires, and suppressant injected to fill the cavity. Or, for example, the microphone can be encased in a ceramic ferrite compartment and injectable attenuating material injected into the cavity of the hearing aid. A smaller amount of injectable suppressant can be injected into the hearing aid cavity so that, for example, rather than fill the cavity, a globule of suppressant is deposited into the center of the cavity, effectively encasing wires in the center of the cavity but not enclosing components.

The attenuating material need not fully radially surround a component or a wire. Partially surrounding a wire can be sufficient. Similarly, partially surrounding a component may be sufficient.

The invention is compatible with any radio-frequency- or magnetic-field-attenuating material, and in particular with any injectable radio-frequency- or magnetic-field-attenuating material, including ferrites, conductive materials, and/or metallic composites and with silicone and other attenuant-bearing materials. Those skilled in the art will be aware of these and other modifications and variations to the invention, the scope of which is limited only by the following claims.

What is claimed is:

1. A hearing aid comprising:
a hearing aid shell;
a microphone;
a receiver; and
an amplifier, said microphone, receiver, and amplifier being located within said shell, said microphone, amplifier and receiver being electrically connected, wherein a radio-frequency-attenuating material is disposed within said shell.

2. A hearing aid as in claim 1 further comprising an analog-to-digital converter, a processor, and a digital-to-analog converter.

3. A hearing aid as in claim 1 wherein said radio-frequency-attenuating material substantially fills unoccupied space in said shell containing said microphone, receiver, amplifier, and wires.

4. A hearing aid as in claim 1 wherein said radio-frequency-attenuating material substantially surrounds at least one of said microphone, receiver, and amplifier.

5. A hearing aid as in claim 1 wherein said radio-frequency-attenuating material substantially surrounds at least one of said wires.

6. A method of producing a hearing aid with improved electromagnetic immunity, comprising the steps of:
placing a radio-frequency-attenuating material around a hearing aid component within a hearing aid shell.

7. The method of claim 6 wherein said component is chosen from the set of microphone, amplifier, receiver, analog-to-digital converter, digital-to-analog converter, processor, and battery.

8. The method of claim 6 wherein said radio-frequency-attenuating material is placed around plural components.

9. The method of claim 8 wherein said plural components are chosen from the set of microphone, amplifier, receiver, analog-to-digital converter, digital-to-analog converter, processor, and battery.

10. The method of claim 6 wherein said radio-frequency-attenuating material primarily attenuates magnetic fields.

11. The method of claim 6 wherein said radio-frequency-attenuating material primarily attenuates electrical fields.

12. The method of claim 6 wherein the radio-frequency-attenuating material is chosen from the set of ferrites, ceramic ferrites, iron particles, mu-metals, conductive materials, and metallic composites.

13. The method of claim 6 wherein the radio-frequency-attenuating material is distributed in silicone rubber.

14. The method of claim 12 wherein the radio-frequency-attenuating material is distributed in silicone rubber.

15. The method of claim 6 wherein the radio-frequency-attenuating material is injectable.

16. The method of claim 6 wherein the radio-frequency-attenuating material is moldable.

17. The method of claim 6 wherein the radio-frequency-attenuating material does not require a sintering step.

18. A method of producing a hearing aid with reduced electromagnetic interference, comprising the steps of:
placing a radio-frequency-attenuating material around a wire between two hearing aid components.

19. The method of claim 18 wherein said two components are chosen from the set of microphone, amplifier, receiver, analog-to-digital converter, digital-to-analog converter, proessor, and battery.

20. The method of claim 18 wherein said component is placed within a shell of said hearing aid before said radio-frequency-attenuating material is placed into said shell.

21. The method of claim 18 wherein said radio-frequency-attenuating material is placed within said shell before said component is placed within said shell.

22. The method of claim 18 wherein said component is placed within a shell of said hearing aid before said radio-frequency-attenuating material is placed into said shell.

23. The method of claim 18 wherein said radio-frequency-attenuating material is placed within said shell before said component is placed within said shell.

24. The method of claim 1 wherein said radio-frequency-attenuating material is incorporated into said hearing aid shell.
